(19) United States
(12) Patent Application Publication
(10) Pub. No.: US 2006/0069540 A1
(43) Pub. Date: Mar. 30, 2006

(54) Methodology for assessing the maturity and capability of an organization's computer forensics processes

(76) Inventor: Ronald L. Krutz, Gibsonia, PA (US)

Correspondence Address: MARTIN & HENSON, P.C., 9250 W 5TH AVENUE, SUITE 200, LAKEWOOD, CO, 80226, US

(21) Appl. No.: 10/952,537

(22) Filed: Sep. 28, 2004

(51) Int. Cl. G06F 9/45

(52) U.S. Cl. 703/22

(57) ABSTRACT

A method for assessing capability and maturity of an organization's computer forensics processes defines an architecture for a computer forensics capability and maturity model (CMM), a computer forensics CMM appraisal method, implements the computer forensics CMM for improving computer forensics processes within the organization, and conducts an appraisal of the organization according to the CMM appraisal method.

### BACKGROUND OF THE INVENTION

The present invention broadly relates to the fields of computer forensics and statistical analysis. More particularly, the invention concerns the application of statistical process controls within the context of a computer forensics environment.

Computer forensics has been described as “obtaining and analyzing digital information for use as evidence in civil, criminal, or administrative cases”. This is according to the Nelson, W., et. al., “Guide to Computer Forensics and Investigation”, Thomson Course Technology, 2004. The same text describes network forensics as “acquiring information about which ports were used to access a computer or which ports a computer accessed to commit a crime.” The science of computer forensics has evolved from the needs of law enforcement for a structured methodology to investigate computer crime. Indeed, the drive toward pervasive interconnectivity and interoperability of networks, computers, applications, and even enterprises is creating a pivotal role for computer forensics in investigating computer crime.

To understand the practice of computer forensics, it can be helpful to appreciate certain fundamental privacy principles that have been adopted by governmental and privacy organizations in other contexts. These include notice regarding collection, use and disclosure of personally identifiable information (PII); choice to opt out or opt in regarding disclosure of PII to third parties; access by consumers to their PII to permit review and correction of information; security to protect PII from unauthorized disclosure; and enforcement of applicable privacy policies and obligations. One or more of these principles have been embodied in various legislations and rules, among them: (1) the Cable Communications Policy Act; (2) the Children's Online Privacy Protection Act (COPPA); (3) customer proprietary network information rules; (4) the Electronic Communications Privacy Act; (5) the Financial Services Modernization Act (Graham-Leach-Bliley); (6) the Telephone Consumer Protection Act; (7) the U.S. Code of Fair Information Practices; (8) the USA Patriot Act; (9) the European Union (EU); and (10) the Organization for Economic Cooperation and Development (OECD).

In 1984 the FBI, working with other law enforcement agencies, developed approaches to collecting and analyzing computer evidence. Because computer evidence is volatile and can be found in numerous components and locations, new paradigms were developed to address the acquisition, preservation, retrieval, and presentation of collected data. As an example, the FBI created the Computer Analysis and Response Team (CART) to analyze computer evidence. In order to develop standards for computer forensic science, the FBI convened international conferences in 1995 in Baltimore, Md.; in 1996 in Australia, and in the Netherlands in 1997. The result of these conferences was the establishment of the Scientific Working Group on Digital Evidence (SWGDE) to address computer forensics issues and standards.

In 1998, the U.S. National Institute of Justice (NIJ) established the Technical Working Group for Electronic Crime Scene Investigation (TWGECSI) with the assignment to “identify, define, and establish basic criteria to assist agencies with electronic investigations and prosecutions.” The working group is comprised of experts from federal, state, and local law enforcement agencies, prosecutors and district attorneys general, criminal justice agencies, commercial, academic, and professional organizations. As a result of the group's efforts, the “Electronic Crime Scene Investigation: A Guide for First Responders,” was published by the U.S. Department of Justice, Office of Justice Programs, National Institute of Justice, in July, 2001. This document is intended to be the first in a series to address computer forensics methods. As stated in the TWGESI guide, computer forensics should be understood and applied by anyone encountering a crime scene that might contain electronic evidence, anyone processing a crime scene that involves electronic evidence, anyone supervising someone who processes such a crime scene and, anyone managing an organization that process such a crime scene. Understandably, then, federal, state, and local law enforcement agencies are the primary practitioners of computer forensics. The TWGESI guide identifies the computer forensics areas to be crime scene investigation by first responders, examination of digital evidence, investigative uses of technology, investigating electronic technology crimes, creating a digital evidence forensic unit, and courtroom presentation of digital evidence.

Modern statistical process control emphasizes that higher quality results can be achieved more cost-effectively by emphasizing the quality of the processes that produce them and the maturity of the organizational practices inherent in those processes. A process can be considered as the sequence of steps performed for a given purpose. It is thus the system of tasks, supporting tools, and people involved in the production and evolution of some end result (e.g., product, system, or service). Realizing that process is one of the determinants of cost, schedule, and quality (others being people and technology), various communities have started to focus on ways to improve their processes for producing products and services. Process capability refers to an organization's potential. It is a range within which an organization is expected to perform. Process performance is the measure of actual results on a particular project that may or may not fall within the range.

Another concept, process maturity, indicates the extent to which a specific process is explicitly defined, managed, measured, controlled, and effective. Process maturity implies a potential for growth in capability and indicates both the richness of an organization's process and the consistency with which it is applied throughout the organization. In “Characterizing the Software Process” by Humphrey, W. S., IEEE Software, Vol. 5, No. 2, March, 1988, pp. 73-79, Humphrey describes a software-process maturity framework that interprets the work of W. Edwards Deming for the software development process. The work interpreted was “Out of the Crisis” by Deming, W. Edwards, Massachusetts Institute of Technology, Center for Advanced Engineering Study, Cambridge, Mass., 1986. Humphrey asserted, “While there are important differences, these concepts are just as applicable to software as they are to automobiles, cameras, wristwatches, and steel. A software-development process that is under statistical control will produce the desired results within the anticipated limits of cost, schedule, and quality.”

An important point is that statistical control of a process needs to be established in order to identify where effective improvements can be made. Towards this end, many organizations have used the Capability Maturity Model (CMM) paradigm as a guide to assist them in achieving statistical process control, and it is widely used as a basis for assessing the capability and maturity of organization in a particular domain. The CMM was developed in 1986 at the Carnegie Mellon University Software Engineering Institute (SEI) and initially applied to the domain of Software Engineering as the Software-CMM (SW-CMM.) The SW-CMM is now considered a legacy model by the SEI and is one of the models that has been incorporated into the new Capability Maturity Model® Integration (CMMI) Product Suite. The CMMI Product Suite addresses systems engineering, software engineering, Integrated Product and Process Development (IPPD), acquisition, and supplier sourcing. The CMM concept has been applied to other domains as well, including systems engineering, acquisition, and systems security engineering.

A CMM is a framework for evolving an organization from an ad hoc, less organized, less effective state to a highly structured and highly effective state. Use of such a model is a means for organizations to bring their practices under statistical process control in order to increase their process capability. A common misconception is that CMMs define a specific process. CMMs provide guidance for organizations to define their processes and then improve the processes over time. The guidance applies regardless of the particular processes that are performed. CMMs thus describe what activities must be performed to help define, manage, monitor, and improve the organization's process(es) rather than exactly how the specific activities must be performed. When reading a CMM, it is easy to be overwhelmed by the overabundance of implied processes and plans. CMM related materials include requirements to document processes and procedures to ensure they are performed and documented.

As a result of applying the CMM in a software domain, many software organizations have shown favorable results with regard to cost, productivity, schedule, and quality. One such example is described in the SEI's “Benefits of CMM-Based Software Process Improvement: Initial Results,” SEI-94-TR-013, 1994. In applying the concepts of statistical process control to software process, Humphrey describes levels of process maturity that guide organizations in improving their process capability in small, incremental steps, and these levels form the basis of the SEI CMM for Software.

Based on analogies in the software and other communities, some results of process and product improvement can be predicted. A first improvement expected as an organization matures is predictability. As capability increases, the difference between targeted results and actual results decreases across projects. A second expected improvement is control. As process capability increases, incremental results can be used to establish revised targets more accurately. Alternative corrective actions can be evaluated based on experience with the process and other project's process results in order to select the best application of control measures. As a result, organizations with a higher capability level will be more effective in controlling performance within an acceptable range. A third expected improvement as an organization matures is process effectiveness. Targeted results improve as the maturity of the organization increases. As an organization matures, costs decrease, development time becomes shorter, and productivity and quality increase. In a Level 1 organization, development time can be quite long because of the amount of rework that must be performed to correct mistakes. In contrast, organizations at a higher maturity level can obtain shortened overall development times via increased process effectiveness and reduction of costly rework.

There are various known, ongoing CMM-related efforts. However, despite their pervasiveness, none comprehensively targets the practice of computer forensics. Computer forensics, in particular, is a field in which a wide variety of organizations are involved with handling and processing computer-related evidence, and it is believed that more efficient processes are warranted given the increasing cost and time required for the acquisition and protection of such evidence. The present invention is primarily directed to satisfying this need.

### BRIEF SUMMARY OF THE INVENTION

It is an object of the present invention to provide a new and improved tool for organizations to evaluate, and improve upon, their computer forensics practices.

Another object of the present invention is to provide a basis for evaluating an organizations' computer forensics competence.

A further object of the present invention is to provide a new and improved method of defining an architecture for a computer forensics capability and maturity model.

Yet another object of the present invention is to provide a new and improved method for assessing capability and maturity of an organization's computer forensics processes.

In accordance with objectives, the present invention in one sense relates to a method of defining an architecture for a computer forensics capability and maturity model, whereby the architecture is to be used for evaluating an organization's computer forensics processes. According to this embodiment of the methodology, a plurality of process areas are established relating to the domain of computer forensics. A plurality of forensics base practices are also established, each corresponding to a fundamental characteristic that is practiced in the computer forensics domain. The base practices are correlated to the process areas, whereby related ones of them are respectively grouped as a sub-set within each process area according to a common purpose.

A first group of process areas preferably relates to technical and operational base practices within the computer forensics domain, while a second group preferably relates to administrative and operational base practices within the computer forensics domain. To this end, the first group of process areas corresponds to one or more of:
(a) identifying electronic devices as potential sources of evidence;
(b) providing access to investigative tools and equipment;
(c) securing and evaluating a crime scene;
(d) documenting a crime scene;
(e) collecting evidence;
(f) packaging, transporting and storing evidence;
(g) conducting forensic examination of evidence;
(h) providing access to a computer forensics laboratory;
(i) generating investigation reports; and
(j) present evidence in a legal proceeding.
   The second group of process areas corresponds to one or more of:
(a) ensuring quality; and
(b) providing ongoing skills and knowledge.

The methodology also preferably comprises establishment of a plurality of generic practices, each being common to all of the process areas. The process areas are thus categorized under a domain dimension of the computer forensics capability and maturity model, while the generic practices are categorized under a capability dimension of the model.

Preferably, the generic practices are grouped according to common features for evaluating the capability and maturity of computer forensics processes, thereby to define a plurality of common features each having an associated sub-set of generic practices. The common features are then grouped according to computer forensics processes capability levels to define a plurality of capability levels each having an associated sub-set of common features. To this end, the capability levels may include: (1) a first capability level indicative of an informally performed process; (2) a second capability level indicative of a planned and tracked process; (3) a third capability level indicative of a well defined process; (4) a fourth capability level indicative of a quantitatively controlled process; and (5) a fifth capability level indicative of a continuously improving process.

Another exemplary embodiment of the methodology of the present invention relates to assessing capability and maturity of an organization's computer forensics processes. According to this methodology, an architecture for the computer forensics capability and maturity model (CMM) is defined, preferably as set forth above. A computer forensics CMM appraisal method is also defined. The computer forensics CMM is implemented for improving computer forensics processes within a test organization. An appraisal is then conducted of the organization according to the computer forensics CMM appraisal method, thereby to derive a respective resultant capability level for each of the computer forensics processes within the organization. An overall assessment is thus obtained of the capability and maturity of the organization's computer forensics processes.

These and other objects of the present invention will become more readily appreciated and understood from a consideration of the following detailed description of the exemplary embodiments of the present invention when taken together with the accompanying drawings, in which:

### BRIEF DESCRIPTION OF THE DRAWINGS

FIG. 1 is a summary chart, which diagrammatically represents the Computer Forensics CMM of the present invention at a high level of abstraction;

FIG. 2 is a prior art diagrammatic representation of the high level steps embodied by the Initiating, Diagnosing, Establishing, Acting, Learning (IDEAL) approach, whereby an organization can undertake a concerted process improvement effort;

FIGS. 3(a) & 3(b) visually illustrate, respectively in the form of a bar chart and a table, representative capability level results for each PA analyzed; and

FIG. 4 is a high level flowchart of a method for assessing capability and maturity of an organization's computer forensics processes, according to one exemplary embodiment of the present invention.

### DETAILED DESCRIPTION OF THE INVENTION

### Introduction

As mentioned in the Background section above, there are a variety of ongoing CMM-related efforts, but none comprehensively targets the practice of computer forensics. In fact, applying the CMM paradigm to a field comprising computer crime investigation, evidence preservation, and witness courtroom testimony is not intuitive. The Computer Forensics CMM differs from historical CMM models in that it focuses on investigative skills and prosecution issues instead of engineering and related fields.

It is important that personnel conducting computer crime investigations adhere to basic principles and best practices which, in the inventor's view, have been recognized or adopted in the field of computer forensics. In the Computer Forensics Capability Maturity Model (“Computer Forensics CMM”) described herein, these basic principles and best practices have been compiled by the inventor from a variety or resources, and quantified into processes that can be used as a metric of an organization's computer forensics' capabilities. Thus, the Computer Forensics CMM of the present invention provides a standard metric for evaluating an organization's maturity in meeting Computer Forensics requirements. Also introduced herein is a Computer Forensics CMM Appraisal Method (CFAM) for grading an organization's computer forensics practices against the Computer Forensics CMM.

The Computer Forensics CMM and the CFAM are intended to be used, both separately and collectively, as a tool for organizations to evaluate their computer forensics practices and define improvements to them. They also can provide a basis for evaluation of an organizations' adherence to accepted methods, as well as a standard mechanism for customers to evaluate a provider's computer forensics practices. The Computer Forensics CMM was developed with the anticipation that applying the concepts of statistical process control to computer forensics processes will promote the compliance of computer forensics-related systems within anticipated limits of cost, schedule, time, legal requirements, and quality. The basic philosophy behind Computer Forensics CMM is to empower computer forensics-related organizations to develop and improve a process that is most effective for them. This approach is based on the ability to define, document, and manage the process, and standardize the process throughout the entire organization.

Various global benefits can be realized upon implementation of the Computer Forensics CMM of the invention. One is continuity through the use in future efforts of knowledge acquired in previous efforts. Another is reliability by providing a way to ensure activities can repeat a successful effort. Other benefits include efficiency for developers and evaluators and assurance based on confidence that computer forensics needs are being addressed.

More specific benefits can also be realized. For example, benefits to evaluation organizations (e.g. investigators, attorneys, certifiers, accreditors, and product assessors) may include: (1) reusable process results, independent of system or product changes; (2) confidence in computer forensics accepted practices; and (3) capability-based confidence in evidence, reducing evaluation workload. Moreover, computer crime investigative organizations can specifically achieve efficiency and reliability from the use of repeatable, predictable processes and practices; confidence in meeting the requirements of computer forensics basic principles and best practices; and focus on measured organizational competency (maturity) and improvements. Acquirers include organizations acquiring products, and services from external/internal sources and end users. Specific benefits to acquirers include reusable standard Request for Proposal language and evaluation means; reduced risks (performance, cost, schedule) of choosing an unqualified bidder; fewer protests due to uniform assessments based on accepted practices; and predictable, repeatable level of confidence in product or service.

Various terms and concepts are discussed throughout the description and the claims which should have particular meaning to those familiar with CMMs. Other terms will perhaps be more familiar to those conversant in the areas of computer forensics. Still other concepts specific to the model are discussed in the sections of the model description below which address them. An appreciation of these terms and concepts can be helpful to an effective understanding, interpretation, and use of the Computer Forensics CMM.

Two terms used within the Computer Forensics CMM to differentiate aspects of organizational structure are “organization” and “project”. Other constructs such as teams exist within business entities, but there is no commonly accepted terminology that spans all business contexts. These two terms were chosen because they are commonly used/understood by most of the anticipated audience of the Computer Forensics CMM. The term “organization” is to be understood as a unit within a company, the whole company or other entity (e.g., government agency or law enforcement department), responsible for the oversight of multiple activities. All projects within an organization typically share common policies at the top of the reporting structure. An organization may consist of co-located or geographically distributed projects and supporting infrastructures. The term is used to connote an infrastructure to support common strategic, business, and process-related functions. The infrastructure exists and must be maintained for the organization to be effective in producing, delivering, and supporting its services and products. The “project” is the aggregate of effort and other resources focused on developing and/or maintaining a specific product or providing a service. The product may include hardware, software, and other components and the service may be providing computer forensic investigations.

As described in MIL-STD-499B systems engineering, the term “system” can be considered as (1) an integrated composite of people, products, services, and processes that provide a capability to satisfy a need or objective; (2) an assembly of things or parts forming a complex or unitary whole (i.e., a collection of components organized to accomplish a specific function or set of functions); or (3) an interacting combination of elements, viewed in relation to function. A system may be a product that is hardware only, hardware/software, software only, or a service. The term “system” is used throughout the model to indicate the sum of the products or services being delivered to the customer(s) or user(s).

A “process” is a set of activities performed to achieve a given purpose. Activities may be performed iteratively, recursively, and/or concurrently. Some activities may transform input work products into output work products needed for other activities. The allowable sequence for performing activities is constrained by the availability of input work products and resources, and by management control. A well-defined process includes activities, input and output artifacts of each activity, and mechanisms to control performance of the activities. Several types of processes can be mentioned in the Computer Forensics CMM, including “defined” and “performed” processes. A defined process is formally described for or by an organization for use by personnel responsible for Computer Forensics processes.

A process area (PA) is composed of Base Practices (BPs), which are mandatory characteristics that must exist within an implemented computer forensics process before an organization can claim satisfaction in a given PA. These concepts are discussed in greater detail below. The PAs of the Computer Forensics CMM are groups of practices which, when taken together, achieve a common purpose. But the groupings are not intended to imply that all BPs of a process are necessarily performed by a single individual or role. All BPs are written in verb-object format (i.e., without a specific subject) so as to minimize the perception that a particular BP “belongs to” a particular role. This is one way in which the syntax of the model supports the use of it across a wide spectrum of organizational contexts.

“Process capability” relates to the quantifiable range of expected results that can be achieved by following a process. The capability of an organization's process helps to predict the ability of the organization to meet goals. Low capability organizations experience wide variations in achieving cost, schedule, functionality, and quality targets. The CFAM is based upon statistical process control concepts that define the use of process capability. The CFAM can be used to determine process capability levels for each PA within an organization. The capability side of the Computer Forensics CMM reflects these concepts and provides guidance in improving the capability of the Computer Forensics processes that are referenced in the domain side of the Computer Forensics CMM.

“Work product” refers to the documents, reports, files, data, etc., generated in the course of performing any process. Rather than list individual work products for each PA, the Computer Forensics CMM lists examples for a particular BP, to elaborate further the intended scope of a BP. These lists are illustrative only and reflect a range of administrative and organizational product contexts.

The “customer” is the individual(s) or entity for whom a product is developed or service is rendered, and/or the individual or entity that uses the product or service. The concept and usage of the term customer in the Computer Forensics CMM is intended to recognize the responsibility of the computer forensics functions to address the entire concept of customer.

“Institutionalization” refers to the building of infrastructure and corporate culture that establish methods, practices, and procedures, even after those who originally defined them are gone. The process capability side of the Computer Forensics CMM supports institutionalization by providing practices and a path toward quantitative management and continuous improvement. In this way the Computer Forensics CMM asserts that organizations need to explicitly support process definition, management, and improvement. Institutionalization provides a path toward gaining maximum benefit from a process that exhibits sound computer forensics processes.

Finally, “process management” is the set of activities and infrastructures used to predict, evaluate, and control the performance of a process. Process management implies that a process is defined, since it is difficult to predict or control something that is undefined. The focus on process management implies that an organization takes into account process-related factors in planning, performance, evaluation, monitoring, and corrective action.

The Computer Forensics CMM Architecture

A CMM, such as the Computer Forensics CMM, describes the stages through which processes progress as they are defined, implemented, and improved. The model provides a guide for selecting process improvement strategies by determining the current capabilities of specific processes and identifying the issues most critical to quality and process improvement within a particular domain. A CMM may also be used to appraise the existence and institutionalization of a defined process that implements referenced practices. A capability maturity model covers the processes used to perform the tasks of the specified domain (e.g., Computer Forensics).

The Computer Forensics CMM architecture is designed to enable a determination of an organization's process maturity across the breadth of computer forensics-related activities. One of the goals of the architecture is to clearly separate basic characteristics of the Computer Forensics CMM processes from their management and institutionalization characteristics. In order to ensure this separation, the model (as with other CMMs) has two dimensions, referred to as “domain” and “capability”.

The domain dimension consists of all the practices that collectively define computer forensics processes. These practices are called Base Practices, or “BPs.” The capability dimension represents practices that indicate process management and institutionalization capability. These practices are called Generic Practices, or “GPs”, as they apply across a wide range of domains. The GPs represent activities that should be performed as part of doing the BPs. For example, a fundamental part of computer forensics (i.e. a BP) is to protect perishable data. One way to determine an organization's ability to do something is to check whether they have a process for allocating resources to the activities they claim to be doing. This global “characteristic” of mature organizations is thus a GP. Evaluating them together provides a mechanism by which an organization's capability to perform a particular activity cab be assessed. Here, for instance, an interested party might inquire, “Does your organization allocate resources to protect perishable data? If the answer is “yes,” the interviewer learns a little about the organization's capability. Thus, answering all the questions raised by combining all the BPs with all the GPs will provide a good picture of the organization's capability as it relates to computer forensics processes.

In the exemplary embodiment of the invention, the Computer Forensics CMM is comprised of computer forensics-specific BPs, organized into 10 PAs. The BPs were gathered by the inventor from a wide range of existing materials, practice, and expertise. The practices selected are believed to represent the best existing practice of the computer forensics community, not untested practices.

Each BP preferably applies across all aspects of computer crime investigation, does not overlap with other BPs, represents a “best practice” of the computer forensics community, and is applicable using multiple methods in multiple investigative contexts. The BPs have been organized into PAs in a manner which is believed to satisfy the needs of a broad spectrum of computer forensics practitioners and consumers. There are many ways to divide the computer forensics processes into PAs. One might try to model the real world of computer forensics investigations and create PAs that correspond to these services. Other strategies might attempt to identify conceptual areas that form fundamental computer forensics building blocks. In the inventor's view, the Computer Forensics CMM of the present invention presents a compromise between these competing goals in the current set of PAs.

Each PA has a set of goals that represent the expected state of an organization that is successfully performing the PAs. An organization that performs the BPs of the PAs should also achieve its goals. Preferably also, each PA: assembles related activities in one area for ease of use, relates to valuable computer forensics activities, relates to computer forensics requirements, can be implemented in multiple organization and service contexts, can be improved as a distinct process, can be improved by a group with similar interests in the process, and includes all BPs that are required to meet the goals of the PAs.

The technical and operational PAs of the Computer Forensics CMM are summarized in Table I below. These Pas, and the BPs, that define them are described in greater depth in Appendix A which immediate following the description herein.

TABLE I
PA01 - Identify Electronic Devices That Might be Sources of Evidence
PA02 - Provide Access to Investigative Tools and Equipment
PA03 - Secure and Evaluate the Scene
PA04 - Document the Scene
PA05 - Collect the Evidence
PA06 - Package, Transport, and Store the Evidence
PA07 - Corroborate the Evidence Source through Interviews
PA08 - Conduct Forensic Examination by Crime Category
PA09 - Provide Access to Computer Forensics Laboratory
PA10 - Generate Investigation Reports
PA11 - Present Evidence in Court

The Computer Forensics CMM also includes PAs related to administrative and organizational practices. These PAs, are summarized in Table II below and described in greater depth in Appendix B.

TABLE II

PA12 - Ensure Quality
PA13 - Provide Ongoing Skills and Knowledge

GPs are activities that apply to all processes. They address the management, measurement, and institutionalization aspects of a process. In general, they are used during an appraisal to determine the capability of an organization to perform a process. GPs are grouped into logical areas called “Common Features” which are organized into five “Capability Levels” which represent increasing organizational capability. Unlike the BPs of the domain dimension, the GPs of the capability dimension are ordered according to maturity. Therefore, GPs that indicate higher levels of process capability are located at the top of the capability dimension. The preferred Capability Levels, and their associated Common Features, pertaining to the Computer Forensics CMM of the present invention are described in greater detail in Appendix C.

The common features are designed to describe major shifts in an organization's characteristic manner of performing work processes (in this case, the Computer Forensics domain). Each common feature has one or more GPs. For example, the lowest common feature is referred to as 1.1, “BPs are performed”. This common feature simply checks whether an organization performs all the BPs in a PA. Subsequent common features have GPs that help to determine how well an organization manages and improves each PA as a whole. The GPs have a preferred grouping in order to emphasize any major shift in an organization's characteristic manner of addressing computer forensics. The common features summarized in Table III below represent the attributes of mature computer forensics processes necessary to achieve each level. Again, these common features and the GPs that define them are discussed in greater detail in Appendix C

TABLE III

| Level | Common Features |
|---|---|
| 1 | 1.1 BPs are Performed |
| 2 | 2.1 Planning Performance |
| | 2.2 Disciplined Performance |
| | 2.3 Verifying Performance |
| | 2.4 Tracking Performance |
| 3 | 3.1 Defining a Standard Process |
| | 3.2 Perform the Defined Process |
| | 3.3 Coordinate the Process |
| 4 | 4.1 Establishing Measurable Quality Goals |
| | 4.2 Objectively Managing Performance |
| 5 | 5.1 Improving Organizational Capability |
| | 5.2 Improving Process Effectiveness |

The Computer Forensics CMM of the present invention also does not imply specific requirements for performing the GPs. An organization is generally free to plan, track, define, control, and improve their processes in any way or sequence they choose. However, because some higher-level GPs are dependent on lower level GPs, organizations are encouraged to work on the lower level GPs before attempting to achieve higher levels.

The preferred ordering of the common features herein stems from the observation that implementation and institutionalization of some practices benefit from the presence of others. This is especially true if practices are well established. Before an organization can define, tailor, and use a process effectively, individual subunits should have some experience managing the performance of that process. Before institutionalizing a specific scheduling process for an entire organization, for example, an organization should first attempt to use the scheduling process on a subunit. However, some aspects of process implementation and institutionalization should be considered together (not one ordered before the other) since they work together toward enhancing capability.

Common features and capability levels are important both in performing an assessment and in improving an organization's process capability. In the case of an assessment where an organization has some, but not all, common features implemented at a particular capability level for a particular process, the organization usually is operating at the lowest completed capability level for that process. For example, an organization that performs all but one of the Level 2 GPs for some PA should receive a Level 1 rating since it should not reap the full benefit of having implemented a common feature if it is in place when not all common features at lower capability levels have been implemented. An assessment team should take this into account in assessing an organization's individual processes. In the case of improvement, organizing the practices into capability levels provides an organization with an “improvement road map,” should it desire to enhance its capability for a specific process. For these reasons, the practices in the Computer Forensics CMM are grouped into common features, which are ordered by capability levels.

Ideally, an assessment should be performed to determine the capability levels for each of the PAs. This indicates that different PAs can and probably will exist at different levels of capability. The organization will then be able to use this process-specific information as a means to focus on improvements to its processes. Ideally also, the priority and sequence of the organization's activities to improve its processes should take into account its defined goals. There is a preferred order of activities and basic principles that drive the logical sequence of typical improvement efforts. This order of activities is expressed in the common features and GPs of the capability level side of the Computer Forensics CMM architecture.

As with other CMM architectures, the Computer Forensics CMM preferably contains five capability levels. These five levels are informally described below, and described in greater detail in Appendix C. Level 1, “Performed Informally,” focuses on whether an organization performs a process that incorporates the BPs. This level contemplates that it must be done before it can be managed. Level 2, “Planned and Tracked,” focuses on computer forensics definition, planning, and performance issues. This level contemplates that a requisite understanding is required for what the subunit is doing before organization-wide processes can be defined. Level 3, “Well Defined,” focuses on disciplined tailoring from defined processes at the organization level. This level contemplates that things learned from subunits can be used to create organization-wide processes. Level 4, “Quantitatively Controlled,” focuses on measurements being tied to the business goals of the organization. Although it is essential to begin collecting and using basic measures early, measurement and use of data is not expected organization wide until the higher levels have been achieved. Finally, Level 5, “Continuously Improving,” gains leverage from all the management practice improvements from the previous levels, and emphasizes the cultural shifts that will sustain the gains made. This level contemplates that a culture of continuous improvement requires a foundation of sound management practice, defined processes, and measurable goals.

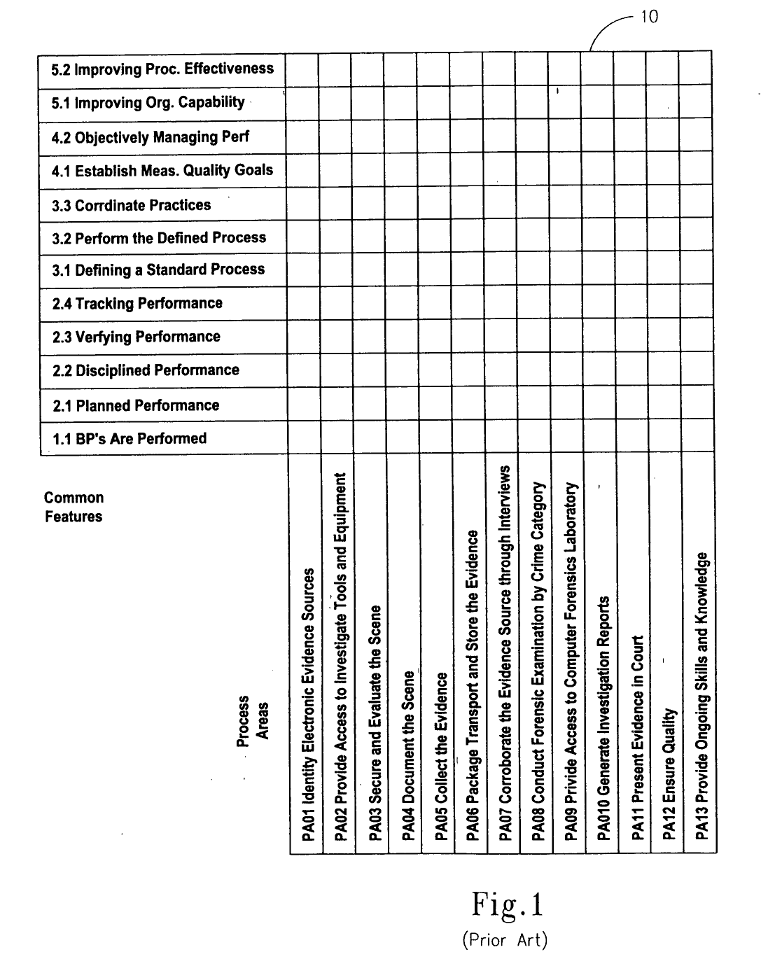

FIG. 1 is a summary chart 10 which diagrammatically represents the Computer Forensics CMM at a high level of abstraction. Again, it is important to recall that each PA preferably comprises of a number of BPs (each described in Appendices A & B), while each common feature preferably comprises of a number of GPs (each described in Appendix C).

Application of the Computer Forensics CMM

The Computer Forensics CMM applies to all computer forensics groups or organizations that are applying or making use of the computer forensics processes. The model can have at least two useful applications—process improvement and capability evaluation. Process improvement enables a computer forensics practitioner to get an idea about their level of computer forensics process capability, to determine if they are satisfying the computer forensics requirements, to design improved computer forensics processes, and to improve their process capability. It allows a consumer organization to understand the computer forensics capability of a provider organization.

As stated above, the Computer Forensics CMM contains practices which, in the opinion of the inventor, describe compliance with computer forensics standards. Thus, it can be useful initially to obtain a baseline of how an organization measures up against one or more of the PAs in the model. With reference again to the summary chart 10 of FIG. 1, a PA can be chosen which is characteristic of the organizational charter, recalling that PAs 1 through 11 focus on the technical and operational aspects of computer forensics, while PAs 11 and 12 focus on administrative and organizational activities. Next, a determination is made as to whether each BP is being performed, either individually or collectively. If all BPs are being performed in some capacity, then a conclusion can be made that the organization is achieving the goals for the Pas, and a check mark can be place in the summary chart 10 for common feature 1.1.

Next, the process can proceed to analyze common feature 2.1 “Planned Performance”, a description for which is found in Appendix C. For the PAs selected, the company should be performing each of the GPs described in common feature 2.1. If so, a check mark can be place in the row for common feature 2.1. These steps can be repeated for each of the remaining common features, thus, giving a good indication of the company's capability to do the Pas selected. When the above steps are completed for each the PAs, the chart will give a good profile of an organization's ability to satisfy computer forensics standards requirements. It is noted that this overall procedure has been globally implemented in other CMM domain applications, but not in the context of computer forensics considerations described herein.

The Computer Forensics CMM can be used as a tool for improving an organization's computer forensics processes. It is preferred that, if an organization wishes to undertake a concerted process improvement effort, that it consider using the Initiating, Diagnosing, Establishing, Acting, Learning (IDEAL) approach developed by the SEI. Additional information about IDEAL currently may be found at http://www.sei.cmu.edu/ideal/ideal.html.

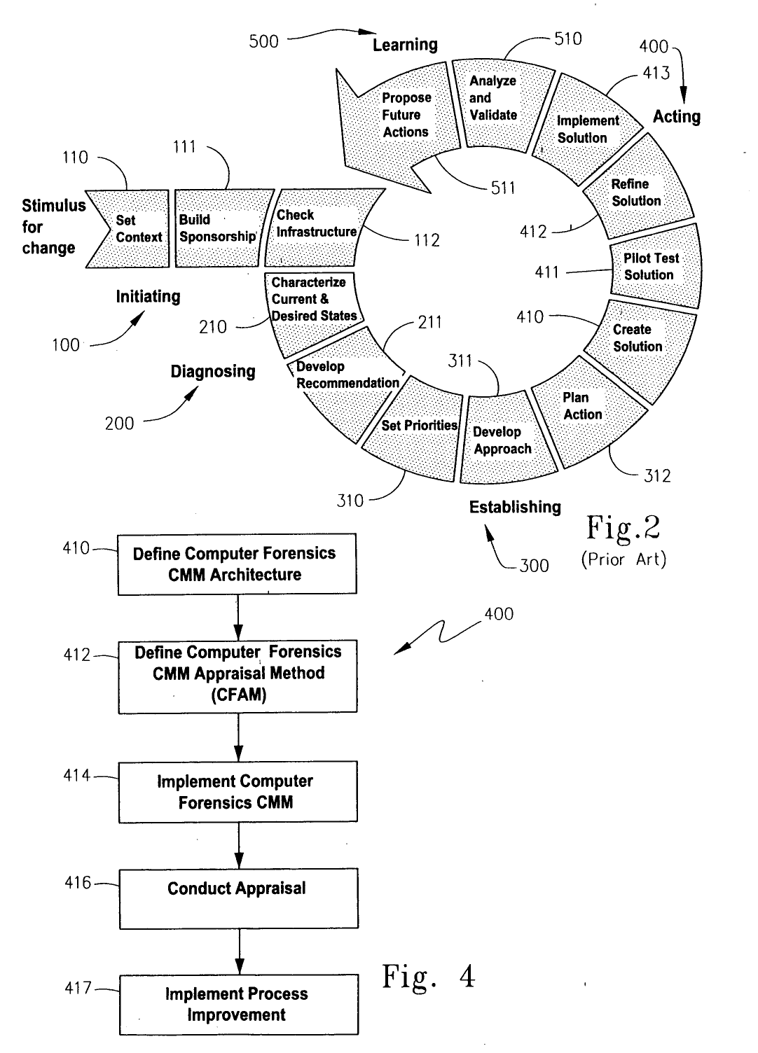

The goal is to get into a continuous cycle of evaluating an organization's current status, making improvements, and repeating. The high level steps for accomplishing this are described below and shown diagrammatically in Prior Art FIG. 2. The step 100 of initiating refers to laying the groundwork for a successful improvement effort. The step 200 of diagnosing refers to determining where one is relative to where one wants to be. The step 300 of establishing refers to planning the specifics of how one will reach the destination. The step 400 of acting refers to doing the work according to the plan. Finally, the step 500 of learning refers to learning from the experience and improving ability. Each of the five phases is made up of several activities. The discussion will now proceed to summarize the application of these activities in the context of a computer forensics-related organization, as contemplated by the Computer Forensics CMM of the present invention.

Embarking upon a computer forensics process improvement effort should be handled in the same manner in which other new activities within an organization are often approached. One should become familiar with the subunit's objectives and means for their accomplishment, develop a business case for the implementation, gain the approval and confidence of management, and develop a method for implementation.

The first step 100 in process improvement is to identify the business reasons for changing the organization's practices. This model is focused on satisfying the computer forensics requirements. However, implementing the processes to meet the computer forensics requirements offers the opportunity to evaluate and streamline processes and increases the efficiency of an organization's operations.

Setting the context for process improvement at 110 relates to how the effort satisfies the computer forensics requirement, supports existing strategies and the specific goals and objectives that will be impacted by changes. Anticipated benefits as a result of the effort should be documented as well as implications for other initiatives and current work.

Effective and continuous support of the effort throughout its lifetime can be essential for successful process improvement. Building sponsorship 111 involves not only making available the financial resources necessary to continue the process, but also personal attention from management. This does not imply that upper management need take a participatory role if such involvement is not warranted. Once the improvement effort is set in motion, management should be periodically apprised of the initiatives and obstacles that stand in the way of its goals being achieved. Problems should never be presented without a solution or proposed solutions, and their cost. By providing evidence of incremental improvement and benefits obtained through process improvement, management may be better inclined to assist the effort if and when problems arise.

After the relationship between the proposed effort and addressing the computer forensics requirements is established, and key sponsors have given their commitment, a mechanism for implementation should be established at 112. The characteristics of the computer forensics management infrastructure will vary depending upon the nature and complexity of the organization chosen and goals of the effort. Ideally, at least one person on a full or part-time basis who is familiar with both the Computer Forensics CMM and the chosen organization should be selected to manage the effort. The management team should be given the resources and the authority to carry out the mission of the process improvement. The goals defined by the team should be clearly outlined and contained in written agreements with all parties involved. The goals should be manageable and easily referenced for evaluating the progress of the effort.

Next comes the diagnosing phase 200. In order to perform process development/improvement activities, it is important that an understanding of the organization's current and desired future state of process maturity be established at 210. These parameters form the basis of the organization's process improvement action plan. The Computer Forensics CMM and related Appraisal Method (CFAM) play a central role in this diagnosing phase.

Step 210 of the diagnosing phase is an extension of the stimulus for change step from the beginning of the initiating phase 100. The business case for initiating the process improvement activity is built on the overall understanding that improving the quality of an organization's processes is beneficial. However, an improvement effort cannot be based on generalities, it must be rooted in a solid understanding of the processes actually employed and the differences between the current and desired state of those processes. By performing a gap analysis of the processes, organizations are better able to identify near and long term improvement goals, their required levels of effort, and likelihood of achievement.

Performing a gap analysis emphasizes the differences between the current and desired states of the organization's processes and reveals additional information or findings about the organization. Grouped according to area of interest, these findings form the basis of recommendations at 211 for how to improve the organization. In order for the recommendations to bear weight, those involved in their development should have not only in-depth knowledge of the organization itself, but also in process improvement methods. This knowledge combination can be crucial because very often management decisions about how to proceed are reflections of the recommendations developed at this stage.

In the establishing phase 300 a detailed plan of action based on the goals of the effort and the recommendations developed during the diagnosing phase 200 are developed. In addition, the plan must take into consideration any possible constraints, such as resource limitations, which might limit the scope of the improvement effort. Priorities along with specific outputs and responsibilities are also put forth in the plan.

Time constraints, available resources, organizational priorities, and other factors may not allow for all of the goals to be realized or recommendations implemented, during a single instance of the process improvement lifecycle. Therefore, the organization preferably establishes priorities for its improvement effort at 310. Priority should be given to those changes in the process that have a direct bearing on the accomplishment of the process improvement effort. For example, if during the diagnosing phase 200. It is determined that the organization is weak in a specific area of computer forensics, focusing resources in that area may be of higher priority than focusing them on another area that is peripheral to the mission.

As a result of the organization characterization defined in the diagnosing phase and in establishing priorities, the scope of the process improvement effort may be different from that developed in the initiating phase 100. The develop approach step 311 requires that the redefined objectives and recommendations be mapped to potential strategies for accomplishing the desired outcomes. The strategies include the identification of specific resources (technical and non-technical) and their inputs, such as specific skills and background conditions, required for proceeding. In addition, factors not directly associated with the improvement effort, organizational culture, financial and managerial support, which may influence change implementation, can be considered and documented.

At this point, all of the data, approaches, recommendations, and priorities are preferably coupled in the form of a detailed action plan at 312. Included in the plan are the allocation of responsibilities, resources, and specific tasks, tracking tools to be used and established deadlines and milestones. The plan should also include contingency plans and coping strategies for any unforeseen problems.

Acting phase 400 is the implementation phase and likely requires the greatest level of effort of all the phases both in terms of resources and time. Achieving the goals of the organization may require multiple parallel cycles within the acting phase 400 in order to address all of desired improvements and priorities.

Solutions, or improvement steps, for each problem area are developed at 410 based on available information on the issue and resources for implementation. At this stage, the solutions are “best guess” efforts of a technical working group. The proposed solutions should reflect a full understanding of the relevant issues impacting the effort and the organization's capacity for improvement, and may involve tools, processes, knowledge, and skills. Depending on the scope of the improvement effort, smaller specialized groups of individuals may be established to tackle particular areas of interest.

The first step in designing processes to meet the needs of an enterprise is to understand the business, product, and organizational context that will be present when the process is being implemented. It can be useful to evaluate certain aspects before the Computer Forensics-CMM can be used for process design. These include how the computer forensics methods are practiced by the organization; how the organization structured to support computer forensics; how support functions are handled; what management and practitioner roles are being used in this organization; and how critical these processes are to organizational success.

Understanding the cultural and legal contexts in which the Computer Forensics CMM will be used is a key to its successful application in process design. This organizational context includes role assignments, organizational structure, and work products. This context should be combined with guidance from Computer Forensics CMM generic and BPs to produce sound administrative and organizational processes that have the potential for deliberate improvement.

Because first attempts at generating solutions rarely succeed, it is ideal to test all solutions at 411 before they are implemented across an organization. How an organization chooses to test its solutions is dependent upon the nature of the area of interest, the proposed solution, and the resources of the organization. Testing may include introducing proposed changes to sub-groups within the organization and validating assumptions.

Using information collected during testing, potential solutions should be modified at 412 to reflect new knowledge about the solution. The importance of the processes under focus as well as the complexity of the proposed improvements will dictate the degree of testing and refinement proposed solutions must undergo before being considered acceptable for implementation throughout the organization. Although desirable, it may be unreasonable to expect the development of perfect processes based on time and resource constraints and priorities. Once a proposed improved process has been accepted it is implemented beyond the test group. Implementation at 413 may occur in a variety of ways depending upon the organization's goals.

Learning phase 500 is both the final stage of the initial process improvement cycle and the initial phase of the next process improvement effort. Here the entire process improvement effort is evaluated in terms of goal realization and how future improvements can be instituted more efficiently. This phase is only as constructive as the detail of records kept throughout the process and the ability of participants to make recommendations.

Determining the success of process improvement entails analyzing the final results in light of the established goals and objectives. It also entails evaluating the efficiency of the effort and determining where further enhancements to the process are required. Thus, the learning phase incorporates an operation 510 of analyzing and validating. The lessons learned are preferably collected, summarized and documented.

Based on the analysis of the improvement effort itself, the lessons learned can be translated into recommendations at 511 for improving subsequent improvement efforts. These recommendations should be promulgated outside those guiding the improvement effort for incorporation into this and other improvement efforts.

The Computer Forensics CMM Appraisal Method

The Computer Forensics CMM is structured to support a variety of improvement activities, including self-administered appraisals, or internal appraisals augmented by expert “facilitators” from inside or outside the organization. It was developed with the understanding that computer forensics practitioners and customers are diverse in nature and vary in size, services delivered and personnel responsibilities and assignments. Therefore, the appraisal method can be customized to recognize these diversities and to support the evaluation of computer forensics processes within these organizations. It is not required that any particular appraisal method be used with the Computer Forensics CMM. However, it is preferred that an appraisal method be designed which is believed to maximize the utility of the model. With this in mind, it the Computer Forensics CMM Appraisal Method (CFAM) should embody certain characteristics.

A suitable appraisal preferably uses multiple data-gathering methods to obtain information on the processes being practiced within the organization for appraisal. The purposes of a CFAM-style would be to obtain a baseline or benchmark of actual practices related to computer forensics processes within the organization, create and support momentum for improvement within multiple levels of the organizational structure, and ensure that the appraisal is repeatable. Data gathering would likely entail questionnaires that directly reflect the contents of the model, a series of structured and unstructured interviews with key personnel involved in the performance of the organization's processes, and review of computer forensics practices evidence generated.

Preferably also, multiple feedback sessions would be conducted with the appraisal participants, and sessions culminated in a briefing to all participants plus the sponsor of the appraisal. The briefing would include capability levels determined for each of the PAs appraised. It also includes a set of prioritized strengths and weaknesses that support process improvement based on the organization's stated appraisal goals.

Various steps might be involved in the appraisal. During a planning phase, a framework is established under which the appraisal will be conducted as well as the preparation of logistical aspects for the on-site phase. Here, the limits and purposes of the appraisal are defined and agreed upon in order to meet the goals established for the appraisal by the sponsor. Also, the final appraisal plan, which documents the PAs and details of the appraisal, is preferably produced and approved. The next phase is the preparation phase. The purpose of the preparation phase is to prepare the appraisal team for the on-site phase, and conduct a preliminary gathering and analysis of data through a questionnaire. The team is familiarized with the details of the appraisal. Also, information about the appraised entity is gathered by administering and collecting data from the questionnaire. The data from the questionnaire is analyzed and supporting evidence is collected. This analysis produces a set of exploratory questions for use in the interviews of Computer Forensics leads and practitioners.

Next is the on-site phase, whose purpose is to explore the results of the preliminary data analysis and provide an opportunity for practitioners at the appraised entity to participate in the data gathering and validation process. Preferably, a briefing of the appraisal process and schedule is made to upper management and executives can provide the context for the appraisal activities. The appraisal process and schedule are presented to all appraisal participants. The computer forensics leads and practitioners are interviewed, and the appraisal results are collated. Preliminary findings are proposed and follow-up questions are presented. A rating is then developed to capture the results of the appraisal. This rating and final findings are presented during a wrap-up meeting.

The purpose of the next phase, referred to as the post-appraisal phase, is to finalize the data analysis begun at the end of the on-site phase and to present the team findings to the appraisal sponsor. In addition, it provides an opportunity for the practitioners to provide comments on the appraisal process for future improvements. A findings report is developed and presented to the sponsor. The team properly disposes of any material from the appraisal site and develops an internal report on lessons learned from the appraisal process.

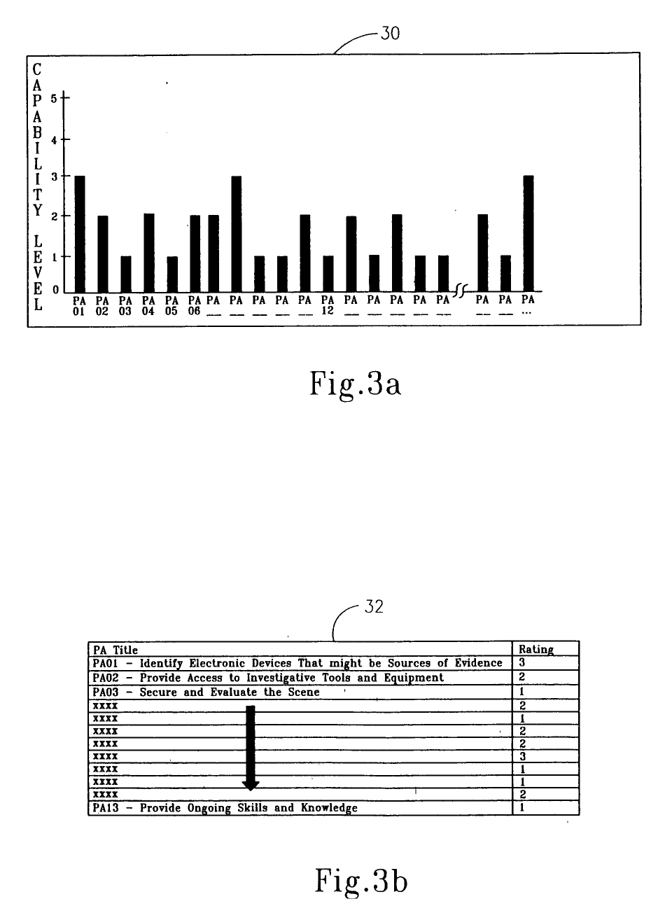

Ultimately, a capability level from 0 to 5 may be determined for each PA and displayed in a simple bar chart 30 or table 32, such as illustrated FIGS. 3(a) & (b), respectively. The actual results of an appraisal include significant detail about each of the areas in this summary and detailed findings. Because compliance with the BPs of all the PAs is evaluated in Level 1, satisfying the Level 1 requirements denotes computer forensics competence, because these requirements are embodied in the BPs. Achieving higher levels is a goal that the appraised organization should work toward since these levels are important in maintaining higher competency levels over time and implementing continuous process improvement.

The first step in assessing an organization is to determine the context within which computer forensics processes are practiced in the organization. Determination of the context needs to be made in order to decide which PAs are applicable to the organization, how the PAs should be interpreted, which personnel need to be involved in the assessment, and whether the results can be repeated? The intent is to focus on those in the organization having the responsibility for executing computer forensics.

The first step in developing a profile of an organization's capability to perform its computer forensics requirements is to determine whether the basic computer forensics processes (i.e., all the BPs) are implemented within the organization (not just written down) via their performed processes. The second step is to assess how well the characteristics (BPs) of the processes that have been implemented are managed and institutionalized by looking at the BPs in the context of the GPs. Consideration of both the BPs and GPs in this way results in a process capability profile that can help the organization to determine the improvement activities that will be of most benefit in the context of its business goals.

In general the appraisal consists of evaluating each PA against the GPs. The BPs should be viewed as guidance on the basic aspects of the topics that need to be addressed. The related GPs deal with deployment of the BPs. Notably, the application of the GPs to each PA results in a unique interpretation of the GP for the subject PA.

The practices of many of the PAs are expected to be repeated a number of times in the execution of an organization's processes. The PAs should be considered a source for practices whenever there is a need to incorporate the purpose of a PA in an organizational process. In an appraisal, it is helpful to remember that the Computer Forensics CMM does not imply a sequence of these practices. Sequencing should be determined based on an organization's operational parameters.

It is of paramount importance that customer needs for computer forensics functionality and assurance be accurately recorded, understood, and translated into computer forensics assurance requirements for a system. The Computer Forensics CMM specifically includes processes designed to achieve these goals. An organization's Computer Forensics CMM rating would represent the proposition that certain processes were followed throughout the spectrum of computer forensics activities. As with other CMM domain applications, this rating can be used to support an organization's claims about meeting the computer forensics requirements.

From the above, it may be appreciated that the present invention contemplates a high level methodology 400, as shown in the flowchart of FIG. 4, for assessing capability and maturity of an organization's computer forensics process. According to methodology 400, an architecture for a computer forensics CMM is defined at 410, preferably in accordance with the foregoing description. Also defined is a computer forensics CMM appraisal method (CFAM) at 412, also in accordance with the above. The computer forensics CMM is implemented at 414 for improving the computer forensics processes within an organization. Then, at 416, an appraisal is conducted of the organization. This appraisal is conducted according to the CFAM thereby to derive a respective resultant capability level for each of the computer forensics processes within the organization, and to obtain an assessment of the capability and maturity of the organization's computer forensics processes. The process capability side of the Computer Forensics CMM supports a path toward continuous improvement. Continuous improvement against quantitative performance goals is enabled by quantitative feedback from performing the defined process and from applying innovated ideas and technologies. Accordingly, methodology 400 may also include a step 417 in FIG. 4 for implementing process improvement.

Accordingly, the present invention has been described with some degree of particularity directed to the exemplary embodiments of the present invention. It should be appreciated, though, that the present invention is defined by the following claims construed in light of the prior art so that modifications or changes may be made to the exemplary embodiments of the present invention without departing from the inventive concepts contained herein.

What is claimed is:

1. A method of defining an architecture for a computer forensics capability and maturity model, whereby said architecture is to be used for assessing capability and maturity of an organization's computer forensics processes, said model comprising:
a. establishing a plurality of process areas relating to the domain of computer forensics;
b. establishing a plurality of computer forensics base practices, each corresponding to a fundamental characteristic that is practiced in the computer forensics domain;
c. correlating the base practices to the process areas, whereby related ones of said best practices are respectively grouped as a sub-set within each process area according to a common purpose.

2. A method according to claim 1 whereby a first group of said process areas relates to technical and operational base practices within the computer forensics domain, and a second group of said process areas relates to administrative and organizational base practices with the computer forensics domain.

3. A method according to claim 2 whereby said first group of process areas corresponds to one or more of:
(a) identifying electronic devices as potential sources of evidence;
(b) providing access to investigative tools and equipment;
(c) securing and evaluating a crime scene;
(d) documenting a crime scene;
(e) collecting evidence;
(f) packaging, transporting and storing evidence;
(g) conducting forensic examination of evidence;
(h) providing access to a computer forensics laboratory;
(i) generating investigation reports; and
(j) present evidence in a legal proceeding.

4. A method according to claim 2 wherein said second group of process areas corresponds to one or more of:
(a) ensuring quality; and
(b) providing ongoing skills and knowledge.

5. A method according to claim 1 comprising establishing a plurality of generic practices, each being common to all of said process areas.

6. A method according to claim 5 whereby said process areas are categorized under a domain dimension of said computer forensics capability and maturity model and whereby said generic practices are categorized under a capability dimension of said computer forensics capability and maturity model.

7. A method according to claim 5 comprising grouping the plurality of generic practices according to common features for evaluating capability and maturity of computer forensics processes, thereby to define a plurality of common features each having an associated sub-set of generic practices.

8. A method according to claim 7 comprising grouping said plurality of common features according to computer forensics processes capability levels, thereby to define a plurality of capability levels each having an associated sub-set of common features.

9. A method according to claim 8 wherein said capability levels correspond to one or more of:
(a) a first capability level indicative of an informally performed process;
(b) a second capability level indicative of a planned and tracked process;
(c) a third capability level indicative of a well-defined process;
(d) a fourth capability level indicative of a quantitatively controlled process; and
(e) a fifth capability level indicative of a continuously improving process.

10. A method for assessing capability and maturity of an organization's computer forensics processes, comprising:
a. defining an architecture for a computer forensics capability and maturity model (CMM);
b. defining a computer forensics CMM appraisal method;
c. implementing the computer forensics CMM for improving computer forensics processes within an organization;
d. conducting an appraisal of the organization, according to said computer forensics CMM appraisal method, thereby to derive a respective resultant capability level for each of the computer forensics processes within the organization, and to obtain an assessment of the capability and maturity of an organization's computer forensics processes.

11. A method according to claim 10 whereby step (a) comprises:
a. establishing a plurality of process areas relating to the domain of computer forensics;
b. establishing a plurality of computer forensics base practices, each corresponding to a fundamental characteristic that is practiced in the computer forensics domain;
c. correlating the base practices to the process areas, whereby related ones of said best practices are respectively grouped as a sub-set within each process area according to a common purpose.

12. A method according to claim 11 whereby a first group of said process areas relates to technical and operational base practices with the computer forensics domain, and a second group of said process areas relates to administrative and organizational base practices with the computer forensics domain.

13. A method according to claim 12 whereby said first group of process areas corresponds to one or more of:
(a) identifying electronic devices as potential sources of evidence;
(b) providing access to investigative tools and equipment;
(c) securing and evaluating a crime scene;
(d) documenting a crime scene;
(e) collecting evidence;
(f) packaging, transporting and storing evidence;
(g) conducting forensic examination of evidence;
(h) providing access to a computer forensics laboratory;
(i) generating investigation reports; and
(j) present evidence in a legal proceeding.

14. A method according to claim 12 wherein said second group of process areas corresponds to one or more of:
(a) ensuring quality; and
(b) providing ongoing skills and knowledge.

15. A method according to claim 11 comprising establishing a plurality of generic practices, each being common to all of said process areas.

16. A method according to claim 15 whereby said process areas are categorized under a domain dimension of said computer forensics capability and maturity model and whereby said generic practices are categorized under a capability dimension of said computer forensics capability and maturity model.

17. A method according to claim 15 comprising grouping the plurality of generic practices according to common features for evaluating capability and maturity of computer forensics processes, thereby to define a plurality of common feature each having an associated sub-set of generic practices.

18. A method according to claim 17 comprising grouping said plurality of common features according to computer forensics processes capability levels, thereby to define a plurality of capability levels each having an associated sub-set of common features.

19. A method according to claim 18 wherein said capability levels correspond to one or more of:
(a) a first capability level indicative of an informally performed process;
(b) a second capability level indicative of a planned and tracked process;
(c) a third capability level indicative of a well-defined process;
(d) a fourth capability level indicative of a quantitatively controlled process; and
(e) a fifth capability level indicative of a continuously improving process.
